(19) United States
(12) Patent Application Publication
(10) Pub. No.: US 2011/0145995 A1
(43) Pub. Date: Jun. 23, 2011

(54) Bed

(76) Inventor: Henry Minh Le, Upper Darby, PA (US)

(21) Appl. No.: 12/643,024

(22) Filed: Dec. 21, 2009

(51) Int. Cl. A47C 17/86; A61G 7/05

(52) U.S. Cl. 5/722

(57) ABSTRACT

A bed and a method of using the bed are described. In accordance with one implementation, a bed comprises a frame and a support mechanism operably connected to the frame. The support mechanism is configured to support the frame. A mattress comprises a plurality of complementary members. The members have first and second opposing ends and a support device. The first ends of the members are rotatably connected to the frame via a mechanism for positioning the members. Other implementations are described.

### TECHNICAL FIELD

This application relates in general to beds.

### BACKGROUND

When a patient or individual is bed ridden and the sheets on the bed have to be changed, the person generally has to be moved. The person may be lifted off of the bed so that the sheets can be changed. Sometimes the patient may be rolled onto one side of the bed so that the sheets on the opposite side can be removed and replaced, and then the patient may be rolled or moved onto the opposite side of the bed containing the clean sheets so that the remaining “dirty” sheets can be removed and replaced with the clean sheets.

### SUMMARY

This application describes a bed and a method for making the bed.

In accordance with one implementation, a bed comprises a frame and a support mechanism operably connected to the frame. The support mechanism is configured to support the frame. A mattress comprises a plurality of complementary members. The members have first and second opposing ends and a support device. The first ends of the members are rotatably connected to the frame via a mechanism for positioning the members.

In accordance with another implementation, a bed comprises a frame and a support mechanism operably connected to the frame. The support mechanism is configured to support the frame. A mattress comprises a plurality of complementary members. Each member has a first and second opposing end and a support device. The support device is configured to support the member when the member is in a substantially horizontal position. A mechanism for positioning at least one member is operably connected to the frame and the first end of at least one member.

The details of one or more implementations are set forth in the accompanying drawings and the description below. Other features, aspects, and advantages will become apparent from the description, the drawings, and the claims.

It is to be understood that the foregoing general description and the detailed description are exemplary, but not restrictive of the bed or the method of using the bed.

### DESCRIPTION OF DRAWINGS

In the drawings, which are discussed below, one or more implementations are illustrated. It is understood that the bed is not limited to the implementations depicted in the drawings herein, but rather it is defined by the claims appended hereto and equivalent structures.

FIG. 1 is a perspective view of an exemplary implementation of a bed with a person lying on it.

FIG. 2 is a perspective view of the bed of FIG. 1.

FIG. 2A is a partial cutaway perspective view of an exemplary implementation of a flexible shaft assembly that may be used in the bed of FIG. 2.

FIG. 3 is a cross-section cutaway of FIG. 1 with members of the mattress repositioned to an exemplary position.

FIG. 3A is a cross-section cutaway of FIG. 1 with members of the mattress repositioned to an exemplary position.

FIG. 4 shows an exemplary implementation of sheets that may be used with the bed.

FIG. 5 is an exemplary implementation of members of the mattress which may be used with the bed.

FIG. 6 is a partial front view of an exemplary implementation of a bed configured to move a person lying on a bed.

FIG. 7 is an exemplary implementation of a bed.

FIG. 8 shows a cross-section of an exemplary implementation of a bed.

Like reference symbols in the various drawings indicate like elements.

### DETAILED DESCRIPTION

While the specification concludes with claims particularly pointing out and distinctly claiming subject matter, the bed will now be further described by reference to the following detailed description of exemplary implementations taken in conjunction with the above-described accompanying drawings. The following description is presented to enable any person skilled in the art to make and use the bed. Descriptions of specific implementations and applications are provided only as non-limiting examples and various modifications will be readily apparent to those skilled in the art. The general principles defined herein may be applied to other implementations and applications without departing from the spirit and scope of the bed. Thus, the bed is to be accorded the widest scope encompassing numerous alternatives, modifications, and equivalents consistent with the principles and features disclosed herein. For purpose of clarity, details relating to technical material that is known in the technical fields related to the bed have not been described in detail so as not to unnecessarily obscure the present application.

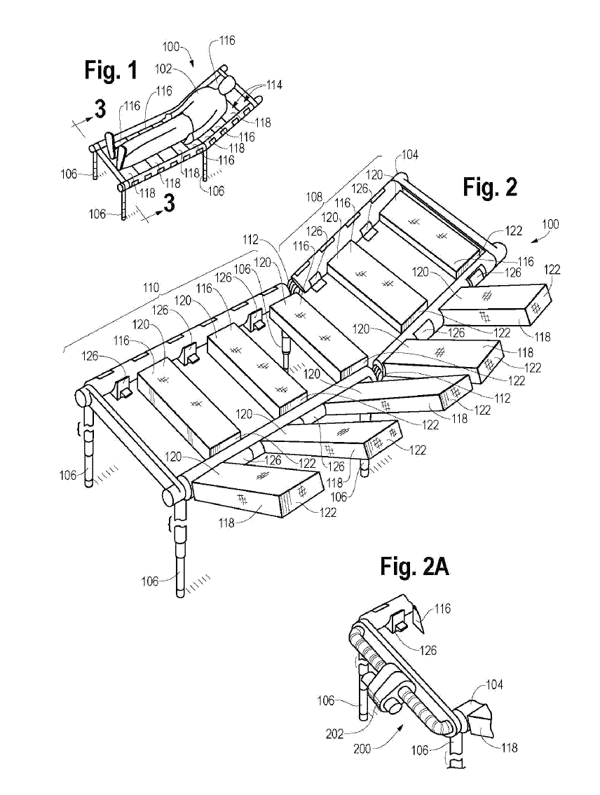

As shown in FIG. 1, an exemplary implementation of a bed 100 has a person 102 lying on it. FIG. 2 shows the bed 100 without a person on it. The bed 100 has a frame 104 which is supported by a support mechanism 106. In some implementations, frame 104 is rectangular in shape. In some implementations, the support mechanism 106 is a base. As shown, the support mechanism 106 is a plurality of legs. In some implementations, the support mechanism 106 may be adjustable. As shown, the legs may be telescoping so that the legs may be raised and lowered. One skilled in the art understands that frame 104 may be mounted on a support mechanism 106 that is any type of conventional bed base known in the art which permits the bed 100 to be used for the purposes described in this disclosure. In some implementations, the support mechanism 106 may include a plurality of casters (not shown) for transporting the bed 100.

As shown in FIG. 2, the bed 100 has a first section 108 and a second section 110. The first section 108 may be adjustable so that it can be raised and lowered. As shown, section 108 has been raised, e.g., it is not level with the second section 110. In some implementations, section 108 may be adjusted by a mechanism 112 for adjusting the height of the section 108. As shown two mechanisms 112, 112 may be used to raise and lower section 108. In some implementations, only one mechanism 112 may be used. In some implementations, mechanism 112 may be motor, gear, crankshaft, air or gas pump, hydraulics, or other electric or manual device capable of raising and lowering section 108.

The bed 100 may have a mattress 114. In some implementations, the mattress 114 may comprise a plurality of complementary members 116, 118. The members 116, 118 have a first end 120 and second end 122, and the first and second ends 120, 122 are opposite each other. In some implementations, at least one end of the members 116, 118 may be releasably connected to the frame. In some implementations, the members 116, 118 may include, without limitation, foam, visco-elastic or memory foam, coil springs, fabric, air, water, bacteria resistant or substantially bacteria resistant material, moisture resistant or substantially moisture resistant material, or a combination of these or other materials generally used in mattresses.

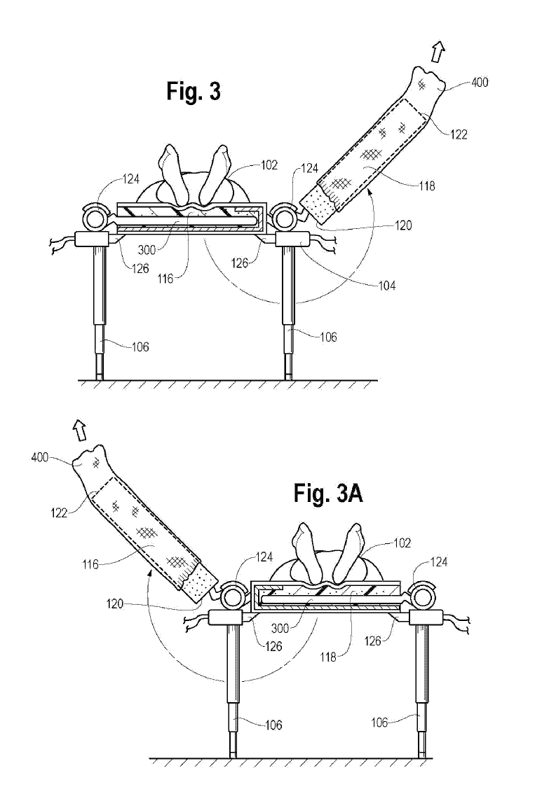

As shown in FIGS. 2 and 3, the first end 120 of the members 116, 118 may be rotationally connected to the frame 104. As shown in FIG. 3, the members 116, 118 may be repositioned by rotating around respective axes of rotation. In some implementations, as shown in FIG. 3, when members 116 are rotated away from the frame 104, a plurality of members 118 remain positioned to support a person 102 lying on the bed 100. In some implementations, as shown in FIG. 3A, when members 118 are rotated away from the frame 104, a plurality of members 116 remain positioned to support a person 102 lying on the bed 100.

In some implementations, the members 116, 118 are rotatably connected to the frame 104 via a mechanism 124 for positioning the members 116, 118. In some implementations, mechanism 124 may be a hinge, a joint, a pivot assembly, a rotation assembly, a swing arm assembly, or any other mechanism suitable for rotating the members 116, 118. In some implementations, mechanism 124 may be electrically operated. In some implementations, mechanism 124 may be manually operated. In some implementations, mechanism 124 may be both manually and electrically operated.

In some implementations, members 116 may be dependently rotatable, e.g., when one member 116 rotates, all members 116 rotate. In some implementations, members 116 may be independently rotatable, e.g., when one member 116 rotates, not all members 116 rotate. In some implementations, members 116 may be both dependently and independently rotatable, e.g., a plurality of members 116 may dependently rotate, but the remaining members 116 may rotate independently from the plurality of dependently rotated members 116. In some implementations, a plurality of members 116 may dependently rotate and remaining members 116 may dependently rotate after the plurality of members 116 are substantially returned to their starting position.

In some implementations, members 118 may be dependently rotatable, e.g., when one member 118 rotates, all members 118 rotate. In some implementations, members 118 may be independently rotatable, e.g., when one member 118 rotates, not all members 118 rotate. In some implementations, members 118 may be both dependently and independently rotatable, e.g., a plurality of members 118 may dependently rotate, but the remaining members 118 may rotate independently from the plurality of dependently rotated members 118. In some implementations, a plurality of members 118 may dependently rotate and remaining members 118 may dependently rotate after the plurality of members 118 are substantially returned to their starting position.

In some implementations, members 116, 118 may be grouped based on which section of the frame they are located. In some implementations, members 116 located on the first section 108 of the frame 104 may be grouped together and the members 116 located on the second section 110 of the frame 104 may be grouped together. In some implementations, members 118 located on the first section 108 of the frame 104 may be grouped together and the members 118 located on the second section 110 of the frame 104 may be grouped together. As shown in FIG. 7, the bed 700 may have three sections 702, 704, 706. In some implementations, the members 116, 118 may be grouped based on which of the three sections (702, 704, 706) they are located.

In some implementations, the mechanism 124 for rotatably connecting the first end 120 of the members 116, 118 to the frame 104 may be electrically controlled. In some implementations, the mechanism 124 may be manually controlled. As shown in FIG. 2A, in some implementations, a flexible shaft assembly 200 may be incorporated into the frame 104 to operate or control the rotation of members 116, 118. In some implementations, the flexible shaft assembly 200 may include at least one controller 202. In some implementations, the controller 202 may be electrically or manually operated.

As shown in FIG. 2, a support device 126 may be operably connected to the frame 104. In some implementations, the support device 126 supports the members 116, 118 when the members 116, 118 form a substantially planar surface and substantially contact the support device 126. In some implementations, when the members 116, 118 form a substantially planar surface and are in substantial contact with the support device 126, a person 102 may lie on the bed 100. In some implementations, when the members 116 or 118 are positioned to form a substantially planar surface, a person 102 may lie on the bed 100 and be substantially supported. In some implementations, when a plurality of members 116, 118 are positioned to form a substantially planar surface, a person 102 may lie on the bed and be substantially supported and other members 116, 118 may be rotated away from the person 102.

As shown in FIG. 2, members 116 are positioned to form a substantially planar surface and members 118 have been rotated away from the frame 104. In some implementations, the support device 126 contacts the second end 122 of the members 116, 118 when the members 116, 118 are positioned to form a substantially planar surface on which a person 102 may lie.

In some implementations, the support device 126 may extend from about 0% to about 100% of the length of the members 116, 118 when the members 116, 118 are positioned to form a substantially planar surface on which a person 102 may lie. In some implementations, the support device 126 may extend to at least about 50% of the length of the members 116, 118 when the members 116, 118 are positioned to form a substantially planar surface on which a person 102 may lie. In some implementations, the support device 126 may extend to about 25% of the length of the members 116, 118 when the members 116, 118 are positioned to form a substantially planar surface on which a person 102 may lie. In some implementations, the support device 126 may extend to about 5% of the length of the members 116, 118 when the members 116, 118 are positioned to form a substantially planar surface on which a person 102 may lie. In some implementations, the support device 126 may be of a sufficient length to contact the second end 122 of the members 116, 118 when the members 116, 118 are positioned to form a substantially planar surface on which a person 102 may lie.

In some implementations, instead of or in addition to support device 126, support device 300 may be incorporated into the members 116, 118. In some implementations, the support device 300 incorporated into the members 116, 118 may be a rod, dowel, or similar structure capable of supporting the members 116, 118 and a person 102 lying or sitting on the bed. In some implementations having a support device 300 incorporated into the members 116, 118, the support device 126 may not be present. In some implementations, the support device 300 incorporated into the members 116, 118 may be operably connected to the mechanism 124 for positioning the members 116, 118.

In some implementations, the support device 300 may extend from about 25% to about 100% of the length of the members 116, 118. In some implementations, the support device 300 may extend to about 100% of the length of the members 116, 118. In some implementations, the support device 300 may extend to at least about 50% of the length of the members 116, 118. In some implementations, the support device 300 may extend to about 25% of the length of the members 116, 118. In some implementations, the support device 300 may extend to about 5% of the length of the members 116, 118. In some implementations, the support device 300 may be of a sufficient length to contact the second end 122 of the members 116, 118.

In some implementations of the bed 100, 500, 700, when the members 116, 118 are positioned to form a substantially planar surface on which a person 102 may lie, the members 116, 118 may be adjacent and substantially parallel to each other. In some implementations, when the members 116, 118 are positioned to form a substantially planar surface on which a person 102 may lie, the members 116, 118 may be sized and positioned so that there are substantially no spaces, gaps, or voids between the members 116, 118.

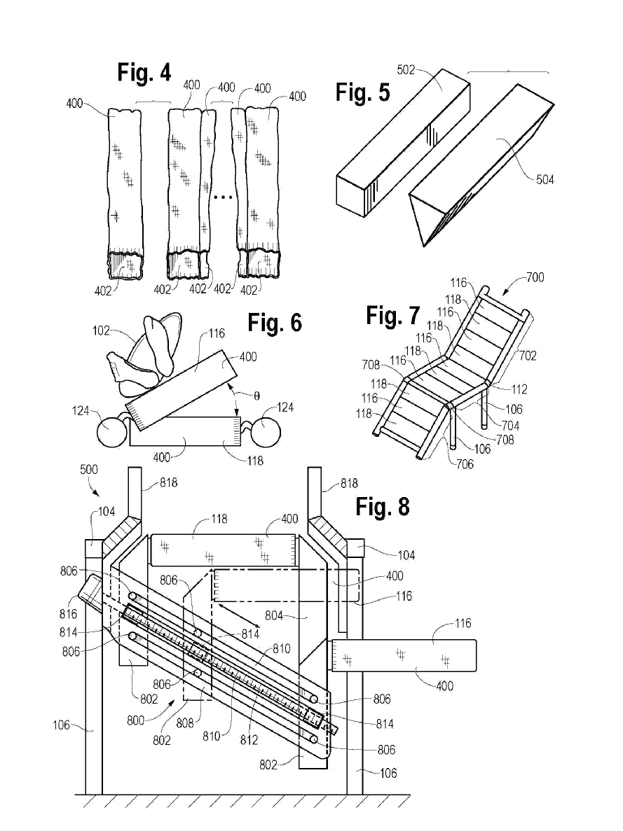

FIG. 4 shows an exemplary implementation of sheets 400 that may be used to protect or cover the members 116, 118 of the mattress 114. In some implementations, the sheet 400 may be a sleeve configured to slide on and off the member 116, 118. As shown in FIG. 3A, the sheet 400 may be slid off of member 118 when member 118 is rotated away from the frame 104. In some implementations, the sheet 400 may be a sleeve that is configured to open and close so that the sheet 400 may be placed over or under the member 116, 118 and then closed to secure the sheet 400 in place; the sheet 400 then may be taken off of the member 116, 118 by sliding the sheet 400 or by opening and then removing the sheet 400. In some implementations having a sheet 400 that is configured to open and close, the mechanism for opening and closing the sheet may be a hook-and-loop fastener, a snap, a button, a buckle, string, laces, an elastic band, or any other suitable mechanism for opening and closing the sheet 400. In some implementations, the sheet 400 may be a sleeve having one open end 402. In some implementations, the sheet 400 may be a sleeve having two open ends.

In some implementations, as shown in FIGS. 2 and 3, the members 116, 118 may be rectangular in shape. In some implementations, as shown in FIG. 5, the members may be square 502 or triangular 504 in shape. In some implementations, the members may be a combination of rectangular and square shapes. In some implementations, the members may be a combination of rectangular and triangular shapes. In some implementations, the members may be a combination of rectangular, square, and triangular shapes. In some implementations, the members may be a combination of square and triangular shapes. It is understood by one skilled in the art that sheets 400 may be made for the various shapes that may be used for the members 116, 118.

As shown in FIG. 6, the bed 100 may be configured to move or assist moving a person 102 lying on the bed 100. In some implementations, the members 116, 118 may be configured to rotate about the axis of rotation substantially to an angle which moves or assists moving the person on the bed. In some implementations, to move a person 102 on the bed 100, members 116 are rotated above the frame 104 at a time different from when members 118 are rotated above the frame 104. In some implementations, as shown in FIG. 6, members 116 are rotated about the axis of rotation substantially to an angle θ which moves or assists moving the person 102 on the bed 100. In some implementations, members 118 also may rotate about the axis of rotation substantially to an angle θ which moves or assists moving the person 102 on the bed 100. In some implementations, the angle θ is about 5° to about 90°. In some implementations, the angle θ is about 15° to about 45°. In some implementations, the angle θ is about 25°. In some implementations, the angle θ is about 30°. In some implementations, the angle θ is about 30°. In some implementations, the angle θ is about 45°.

FIG. 8 shows an exemplary implementation of a bed 500. In some implementations, the bed 500 may have a mechanism 800 for positioning the members 116, 118. As shown in FIG. 8, mechanism 800 for positioning the members 116, 118 may be a travel frame assembly. In some implementations, a travel frame 808 may be operably connected to a support unit 802, 804. As shown, each member 116, 118 may be operably connected to its own support unit 802. In some implementations, a plurality of support units 802 may be operated substantially at the same time. In some implementations, a plurality of support units 804 may be operated at the same time. In some implementations, a plurality of members 116, 118 may be operably connected to the support units 802, 804 so that when one set of support units 802, 804 move, a plurality of members 116, 118 move.

In some implementations, pins 806 may be incorporated into the support units 802, 804. In some implementations, support units 802, 804 may have at least one pin 806. In some implementations, as shown in FIG. 8, each support unit 802, 804 may have two pins 806.

In some implementations, a nut 814 or like device may be incorporated into the support units 802, 804. In some implementations, the support units 802, 804 may be operably connected to a threaded device 812, such as, but without limitation, a screw-type device, via the nut 814 or like device so that the support unit 802 may travel on the threaded device 812. In some implementations, a mechanism 816 for rotating the threaded device 812 may be operably attached to the threaded device 812. In some implementations, one mechanism 816 may operate a plurality of threaded devices 812. In some implementations, one mechanism 816 may be configured to rotate the threaded devices 812 on a plurality of mechanisms 800. In some implementations, the mechanism 816 may be a motor, gear, crankshaft, air or gas pump, hydraulics, or other electric or manual device capable of rotating the threaded device 812. In some implementations, the mechanism 816 may prevent the support units 802, 804 from falling off of the threaded device 812. In some implementations, the threaded device 812 may be configured to prevent the support unit 802, 804 from inadvertently falling off the threaded device 812.

In some implementations, the travel frame 808 may have at least one slot 810. In some implementations, as shown in FIG. 8, the travel frame 808 may have two slots 810, 810. In some implementations, the pins 806 may be positioned in the slots 806 and the slots 806 may serve as a guide for when the support units 802, 804 travel on their respective threaded devices 812.

The bed disclosed herein permits an individual to change the sheets without having to move the person 102 off of the bed. When the individual wishes to change the sheets 400 on the bed 100, 500, 700 it is recommended that the individual check the height of the bed to ensure that members 116, 118 will not hit the floor when being repositioned. If the height of the bed 100, 500, 700 needs to be raised, the individual increases the height of the bed 100, 500, 700 by raising the support mechanism 106. In some implementations, the support mechanism 106 may be adjusted via a motor, gear, crankshaft, air or gas pump, hydraulics, or other electric or manual device capable of adjusting the support mechanism 106. In some implementations, the members 116, 118 may be repositioned by manual or electrical operation to a position that permits the individual to change the sheets 400.

In some implementations of the bed 100 that have electrical operation of mechanism 124, the electric device may release support device 126 before rotating the members 116, 118 around their respective axis of rotation. In some implementations that have manual operation of mechanism 124, the support device 126 is manually released before the members 116, 118 are rotated around their respective axis of rotation. It is not recommended to rotate all members 116, 118 away from the frame 104 at the same time because doing so may result in the person 102 falling through the middle of the frame 104.

In some implementations, as shown in FIG. 3, members 118 may be rotated away from the frame 104 while the person 102 remains supported by members 116. The members 118 may be rotated to a suitable position so that the individual may change the sheets 400 on the members 118. In some implementations, after the members 118 are returned to their starting positions so that the members 118 form a substantially planar surface and are supported by support device 126, as shown in FIG. 3A, members 116 may then be rotated to a suitable position so that the individual may change the sheets 400 on the members 116. After the members 116 are returned to their starting positions, they may be supported by support device 126. In some implementations, not all of the members 116 or 118 are rotated at the same time. In some implementations, support device 300 may be present and support device 126 may not be present.

In some implementations, as shown in FIGS. 2 and 3, the members 116, 118 may be rotated about their respective axis of rotation to about 225° so that an individual may change the sheets on the members 116, 118. In some implementations, the members 116, 118 may be rotated about their respective axis of rotation to about 250°. In some implementations, the members 116, 118 may be rotated about their respective axis of rotation to about 180°. In some implementations, the members 116, 118 may be rotated about their respective axis of rotation to about 180°.

In some implementations of the bed 500, when a mechanism 800 to move the members 116, 118 is present, the individual uses mechanism 816 to move the desired members 116, 118. When mechanism 816 is in use, the threaded device 812 rotates. As shown in FIG. 8 with respect to member 116, in some implementations, as the threaded device 812 rotates, the nut 814 or like device travels on the threaded device 812, causing the support unit 802 to move diagonally downward, which results in the member 116 moving diagonally downward. In some implementations, the support unit 802 may have pins 806 located within slots 810 on the travel frame 808 and the slots 806 may serve as a guide for when the support unit 802 travels on the threaded device 812. In some implementations, when the support unit 802 reaches a predetermined location on the threaded device 812, such as, but without limitation, a location which permits the individual to change the sheet 400 on the member 116, the mechanism 816 stops or prevents further rotating of the threaded device 812. In some implementations, the individual determines when to stop the mechanism 816 from rotating the threaded device 812. In some implementations, mechanism 800 may be designed to prevent the member 116 from inadvertently falling off of the threaded device 812.

In some implementations, after the individual changes the sheet 400 on the member 116, the individual uses mechanism 816 to rotate the threaded device 812 in the opposite direction, and as the threaded device 812 rotates, the nut 814 or like device travels on the threaded device 812, causing the support unit 802 to move diagonally upward, which results in the member 116 moving diagonally upward. In some implementations, when the member 116 returns to its starting position, the mechanism 816 stops or prevents further rotating of the threaded device 812. In some implementations, the individual determines when to stop the mechanism 816 from rotating the threaded device 812. In some implementations, the user then changes the sheets on member 118 using the same procedure.

In some implementations, each travel frame 800 may be operably connected to the frame 104 in the same direction so that the members 116, 118 may be repositioned to the same side of the frame. In FIG. 8, although the travel frame 808 is shown operably connected to the frame 104 in one position, in some implementations, the travel frame 808 may be operably connected to the frame 104 in the opposite position so that the members 116, 118 may be accessed on the left side of the frame 104 (instead of, as shown in the figure, the right side of the frame 104). In some implementations, a plurality of travel frames 808 may be operably connected to the frame 104 in a staggered pattern to form an “X”-like pattern. In some implementations, members 116 may be operably connected to a travel frame 808 that is operably connected to the frame 104 in the direction as shown in FIG. 8 and the members 118 may be operably connected to a travel frame 808 that is mounted to the frame 104 in the opposite direction, so the travel frames appear substantially as an “X”-like pattern and the members 116, 118 may be accessed on opposite sides of the bed 500 to change their sheets 400.

It may be beneficial to move the person 102 to one side of the bed 100 in an effort to prevent the person 102 from getting bed sores. In some implementations of the bed 100, the members 116, 118 may be configured to rotate about their respective axis of rotation substantially to an angle that “rolls,” moves or assists the individual in moving the person 102 toward or closer to one side of the bed. As shown in FIG. 6, in some implementations, members 116 may be rotated about their axis of rotation substantially to an angle θ which moves or assists the individual in moving the person 102 on the bed 100. After the person 102 is moved to one side of the bed 100, members 116 may be returned to their starting position and supported by support device 126. When the person 102 is to be moved toward or closer to the other side of the bed, in some implementations, members 118 may be rotated about their axis of rotation substantially to an angle θ which moves or assists in moving the person 102 on the bed 100.

When a person 102 is lying on the bed 100, 700, he or she may wish to have his or her back or head raised. In some implementations, section 108, 702 may be adjusted by a mechanism 112 for adjusting the height of the section 108, 702. In some implementations, at least one mechanism 112 may be present to adjust the height of the section 108, 702. In some implementations, two mechanisms 112, 112 may be present to adjust the height of section 108, 702. In some implementations, mechanism 112 may be a motor, gear, crankshaft, air or gas pump, hydraulics, or other electric or manual device capable of raising and lowering section 108.

The person 102 lying on the bed 700 may wish to have his or her feet lowered. In some implementations, section 706 may be adjusted by a mechanism 708 for adjusting the height of section 706. As shown in FIG. 7, two mechanisms 708, 708 may be used to raise and lower section 706. In some implementations, only one mechanism 708 may be used to raise and lower section 706. In some implementations, mechanism 708 may be motor, gear, crankshaft, air or gas pump, hydraulics, or other electric or manual device capable of raising and lowering section 706.

A number of implementations have been described. Nevertheless, it will be understood that various modifications may be made without departing from the spirit and scope of the disclosures in this application. As a non-limiting example, additional components may be added to those described above, or components may be removed or rearranged. It is understood by one skilled in the art that the connections, couplings, and attachments described in this disclosure may be direct or indirect connections, couplings, and attachments, respectively.

As another non-limiting example, in some implementations, the members 116, 118 may be rotatably connected to the frame 104 on the same side of the frame 104. In some implementations, the members 116, 118 may be rotatably connected to the right side of the frame 104. In some implementations, the members 116, 118 may be rotatably connected to the left side of the frame 104. In some implementations incorporating mechanism 800, each travel frame 800 may be operably connected to the frame 104 in the same direction so that the members 116, 118 may be repositioned to the same side of the frame.

As another non-limiting example, the bed may be configured so that a plurality of members 116, 118 move or are repositioned at substantially same time. As yet another non-limiting example, although frame 104 is shown in FIG. 2 as being substantially rectangular in shape, the frame may be other shapes. In some implementations, the frame 104 may be square. In some implementations, the frame 104 may not have four sides. In some implementations, the frame 104 may have two sides that are substantially parallel to each other that are not connected to each other at the top and bottom. As a further non-limiting example, in some implementations, guard rails 818 may be attached to the frame 104 to prevent a person 102 from falling off one or more sides of the bed.

As another non-limiting example, in some implementations, the members 116, 118 may be configured to rotate about their respective axis of rotation substantially to an angle which not only may be capable of moving the person 102 on the bed, but also which may be further rotated in the same direction so that an individual may change the sheets 400 on the members 116, 118. In some implementations, members 116 may be rotated about their axis of rotation substantially to an angle θ which permits a person to change the sheets. In some implementations, members 118 also may rotate about their axis of rotation substantially to an angle θ. Although a person 102 is shown in FIG. 6, it is recommended that the person 102 not be on the bed when the members 116, 118 are rotated about the axis of rotation substantially to an angle θ which permits a person to change the sheets. In some implementations, the angle θ is about 5° to about 270°. In some implementations, the angle θ is about 15° to about 180°. In some implementations, the angle θ is about 120°.

As a further non-limiting example, a sensor may be incorporated into the bed. In some implementations, the sensor may prevent the members 116, 118 from rotating about their respective axis of rotation if the members 116, 118 likely will hit the floor when being rotated as shown in FIG. 3. In some implementations, the sensor may prevent the members 116, 118 from rotating if an object may interfere with the rotation. In some implementations, the sensor may be configured to weigh the person 102 lying or sitting on the bed. In some implementations, the sensor may be configured to prevent the members 116, 118 from rotating about their respective axis of rotation if the members 116, 118 likely will hit the floor when being rotated as shown in the FIG. 3 and weigh the person 102 lying or sitting on the bed. In some implementations, the sensor may be configured to prevent the members 116, 118 from rotating about their respective axis of rotation if the members 116, 118 likely will hit the floor when being rotated as shown in the FIG. 3 and prevent the members 116, 118 from rotating if an object may interfere with the rotation. In some implementations, the sensor may be configured to prevent the members 116, 118 from rotating about their respective axis of rotation if the members 116, 118 likely will hit the floor when being rotated as shown in the FIG. 3, prevent the members 116, 118 from rotating if an object may interfere with the rotation, and weigh the person 102 lying or sitting on the bed.

Other implementations are within the scope of the following claims.

What is claimed is:

1. A bed comprising:
a frame;
a support mechanism operably connected to the frame, wherein the support mechanism is configured to support the frame; and
a mattress comprising a plurality of complementary members, wherein the members have first and second opposing ends and a support device, and the first ends are rotatably connected to the frame via a mechanism for positioning the members.

2. The bed of claim 1, wherein the support device comprises a rod.

3. The bed of claim 1, wherein the mechanism for positioning the members comprises at least one of a hinge, a joint, a pivot assembly, a rotation assembly, and a swing arm assembly.

4. The bed of claim 1, wherein the members are configured to rotate about their respective axis of rotation to about 225°.

5. The bed of claim 1, wherein the members are configured to rotate about their respective axis of rotation to about 180°.

6. The bed of claim 1, wherein the members are configured to rotate about their respective axis of rotation substantially up to an angle θ to move or assist moving a person lying on the bed.

7. The bed of claim 6, wherein the angle θ is about 25°.

8. The bed of claim 6, wherein the angle θ is about 45°.

9. The bed of claim 1, wherein a flexible shaft is incorporated into the frame.

10. The bed of claim 1, wherein the bed is configured to have at least two adjustable sections.

11. A bed comprising:
a frame;
a support mechanism operably connected to the frame, wherein the support mechanism is configured to support the frame;
a mattress comprising a plurality of complementary members, wherein each member has a first and second opposing end and a support device, wherein the support device is configured to support the member when the member is in a substantially horizontal position; and
a mechanism for positioning at least one member operably connected to the frame and the first end of at least one member.

12. The bed of claim 11, wherein the support mechanism comprises adjustable legs.

13. The bed of claim 11, wherein the support device comprises a rod.

14. The bed of claim 11, wherein the mechanism for positioning at least one member is configured to rotate the members.

15. The bed of claim 11, wherein the mechanism for positioning at least one member comprises at least one of a hinge, a joint, a pivot assembly, a rotation assembly, a swing arm assembly, and a travel frame assembly.

16. The bed of claim 14, wherein the mechanism for positioning at least one member is configured to rotate the at least one member about its axis of rotation to about 225°.

17. The bed of claim 14, wherein the mechanism for positioning at least one member is configured to rotate the at least one member about its axis of rotation to about 180°.

18. The bed of claim 14, wherein the mechanism for positioning at least one member is configured to rotate the at least one member about its axis of rotation substantially up to an angle θ to move or assist moving a person lying on the bed.

19. The bed of claim 18, wherein the angle θ is about 25°.

20. The bed of claim 18, wherein the angle θ is about 45°.

21. The bed of claim 11, wherein a flexible shaft is incorporated into the frame.

22. The bed of claim 11, wherein the bed is configured to have at least two adjustable sections.
